(19) United States
(12) Patent Application Publication
(10) Pub. No.: US 2022/0210234 A1
(43) Pub. Date: Jun. 30, 2022

(54) CUSTOMER ACTIVATION ON EDGE COMPUTING ENVIRONMENT

(71) Applicant: Level 3 Communications, LLC, Broomfield, CO (US)

(72) Inventors: Timothy Paul Savill, Breckenridge, CO (US); Christopher McReynolds, Boulder, CO (US); Austin Ritchie, Parker, CO (US)

(73) Assignee: Level 3 Communications, LLC, Broomfield, CO (US)

(21) Appl. No.: 17/565,174

(22) Filed: Dec. 29, 2021

Related U.S. Application Data
(60) Provisional application No. 63/132,716, filed on Dec. 31, 2020.

(51) Int. Cl. H04L 67/51; H04L 43/08; H04L 41/0654

(52) U.S. Cl. CPC H04L 67/16; H04L 41/0672; H04L 43/08

(57) ABSTRACT

Systems and methods for recommending and implementing computing services at a provider network site are provided. A provider network may comprise multiple provider sites, such as edge computing sites. Edge computing sites may not be uniform—e.g., they may differ in computing capability, security certification, capacity for expansion, data storage availability, type of network connectivity, etc. An optimization system uses both service information and optimization criteria to determine one or more optimized provider site(s) for hosting a computing service. Further, service information and optimization criteria may be stored and updated to allow the computing service to be dynamically moved in response to a change event, such as a site failure or a determination that an improvement metric exceeds a threshold for a minimum period of time.

### CROSS-REFERENCE TO RELATED APPLICATIONS

This application claims benefit of U.S. Provisional Application No. 63/132,716, titled “Optimizing Network Characteristics,” filed Dec. 31, 2020, and which application is incorporated herein by reference. To the extent appropriate a claim of priority is made to the above-described application.

### BACKGROUND

Customers of provider networks may desire for a provider network to host computing service(s) for the customers. Provider networks may include a plurality of provider sites, such as edge computing sites, to host the customer computing service(s). Provider sites may be geographically diverse and have different capabilities in terms of computing power, security certifications, connectivity, etc. It is with respect to this general environment that examples of the present disclosure may be directed.

### SUMMARY

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

In an example, the present application describes a method comprising receiving service information for a computing service. The method may continue by receiving, through a user interface, optimization criteria, and determining, based on the service information and the optimization criteria, a plurality of provider site candidates for the computing service, including at least a first provider site of a provider network. The method may further comprise deploying the computing service at the first provider site, storing the optimization criteria, automatically determining, based on the stored optimization criteria, a second provider site of the provider network, detecting a change event; and deploying the computing service at the second provider site.

In another example, a system is provided comprising at least one processor and memory, operatively connected to the at least one processor and storing instructions that, when executed by the at least one processor, cause the system to perform a method. In examples, the method performed by the system comprises receiving service information for a computing service. The method may continue by receiving, through a user interface, optimization criteria, and determining, based on the service information and the optimization criteria, a plurality of provider site candidates for the computing service, including at least a first provider site of a provider network. The method may further comprise deploying the computing service at the first provider site, storing the optimization criteria, automatically determining, based on the stored optimization criteria, a second provider site of the provider network, detecting a change event; and deploying the computing service at the second provider site.

In another example, the present application discloses another method comprising receiving service information for a computing service. The method may continue by receiving, through a user interface, optimization criteria, determining optimization data corresponding to the optimization criteria, and determining, based on the service information, the optimization data, and the optimization criteria, a plurality of provider site candidates for the computing service, including at least a first provider site of a provider network. In examples, the method further comprises deploying the computing service at the first provider site, storing the service information, the optimization criteria, and the optimization data, receiving updated information comprising at least one of updated service information, updated optimization criteria, and updated optimization data, and automatically determining, based on the updated information, an updated plurality of provider site candidates for the computing service. In examples, the method may also comprise determining that an improvement metric for deploying the computing service at a second provider site of the updated plurality of provider site candidates exceeds a threshold for a predetermined amount of time; and deploying, in response to determining that the improvement metric exceeds the threshold for the predetermined amount of time, the computing service at the second provider site.

### BRIEF DESCRIPTION OF THE DRAWINGS

FIG. 1 depicts a system for recommending and implementing computing services at network provider site(s) based on optimization criteria according to examples.

FIG. 2 depicts a method for recommending and implementing computing services at network provider site(s) based on optimization criteria according to examples.

FIG. 3 depicts a method for determining whether to move a computing service to a different network provider site according to an example.

FIG. 4 depicts another method for determining whether to move a computing service to a different network provider site according to an example.

FIG. 5 depicts an example computing environment in which aspects of the present systems and methods may be practiced.

### DETAILED DESCRIPTION

In examples, network optimization systems and methods are provided. A customer of a provider network may desire for a particular computing service to be hosted for the customer by the provider network. In examples, the computing service may comprise one or more of a software application, data storage, or other computing services. The computing service may also comprise or require network services to reach one or more customer site(s) and/or resources needed by the computing service(s).

The provider network may comprise multiple provider sites, such as edge computing sites. Edge computing sites may comprise physical locations at which computing services are provided to customer site(s). The edge computing sites may be geographically dispersed in order to limit distance to a customer's site and to decrease latency. In addition, the edge computing sites may not be uniform—e.g., they may differ in computing capability, security certification, capacity for expansion, data storage availability, type of network connectivity (e.g., public internet, private networking, hybrid public/private), etc.

In examples, an optimization system uses both service information and optimization criteria to determine one or more optimized provider site(s) for hosting a computing service. In examples, the service information may comprise information about the computing service to be hosted, such as the type of software application(s) to be executed, data storage requirements, operating system(s), network connectivity (e.g., public internet, private networking, hybrid, etc.), security requirements (e.g., particular security needed, such as payment card industry (PCI) security certification), latency requirements (e.g., maximum average latency), internet protocol (IP) addresses and/or destinations/entities that need to be reached, type of data traffic (e.g., voice, video) that will be sent to and from the service, and the physical location of customer site(s) that will be accessing the hosted service, etc. Optimization criteria may include performance, reliability (e.g., uptime), average latency, cost, security rating, etc.

In examples, some or all of the service information may be received through a user interface or automatically discovered. For example, a user interface may be provided for a customer (or provider representative) to enter some or all of the service information. In some examples, the user interface may be dynamically rendered using a template selected based on the answer(s) to initial question(s) about the service, e.g., type of software application, data storage requirement(s), etc. In other examples, some or all of the service information may be automatically discovered. For example, if the computing service is already being hosted on the provider network, the provider network may already store information related to the type of software application, data storage requirements, type and size of data traffic, IP addresses and/or destinations/entities that need to be reached, physical location of customer site(s), etc.

Similarly, some or all of the optimization criteria may be received through a user interface or automatically determined. For example, a predetermined set of optimization criteria may be presented through a user interface to a user, and the user may be provided an opportunity to rank and/or weight the optimization criteria in terms of importance. In other examples, a standard set of optimization criteria may be used, or optimization criteria specific to a type of service to be hosted may be used. The optimization system may also collect optimization data for each provider site corresponding to the optimization criteria. For example, if an optimization criterion is average latency between a provider site and one or more customer site(s) for a particular type of application specified in the service information, the optimization data for that optimization criterion may be a measured or estimated latency time between the provider site and the customer site(s) (e.g., 5 milliseconds). Optimization data can then be used to determine one or more optimized provider site(s).

In examples, results of the optimization process may be returned as a list of provider site candidates ranked according to the ranked and/or weighted optimization criteria, e.g., as the optimization criteria are selected and/or ordered by the customer. In some examples, the optimization system may employ a scoring matrix to score provider site candidates based on the ranked and/or weighted optimization criteria (and corresponding optimization data for each provider site). The list of provider site candidates may be presented to a user for selection of a provider site to host the service. The list of provider site candidates may be presented along with optimization data for some or all of the optimization criteria so that a user can view, e.g., the estimated costs, performance, reliability, security rating, average latency, etc. associated with each of the provider site candidates in determining a provider site to choose. In examples, the list of provider site candidates may also be sortable by a user on any of the optimization criteria, among other things. For example, the list of provider site candidates may first be presented in ascending order of cost, but it may be then sorted by a user to be ordered in ascending order of estimated latency. In other examples, the list of provider site candidates may be used to automatically cause the computing service to be deployed (or moved, as explained further below) to a particular provider site without a user selection of a particular provider site.

In examples, after an initial deployment of the computing service to a first provider site, updated information may be determined. The updated information may comprise updated service information, updated optimization criteria, and/or updated optimization data. In examples, the optimization criteria, optimization data, and the initial service information may be saved following the initial deployment. Static service information may remain unchanged in the updated service information, such as the type of software application, network connectivity (e.g., public internet, private networking, hybrid, etc.), security requirements (e.g., particular security needed, such as payment card industry (PCI) security certification), etc. However, other service information that may have been estimated for the initial deployment may be replaced with information about the computing service as it has been actually deployed at the first provider site. For example, actual metrics may be determined for the data storage being used, operating system(s) used, average latency, internet protocol (IP) addresses and/or destinations/entities being connected, type and size of data traffic (e.g., voice, video) that is being sent to and from the service, and the physical location of customer site(s) that have been accessing the hosted service, etc. In examples, updated service information may be determined and/or redetermined periodically and/or in response to a change event (discussed below).

The optimization criteria and updated optimization data may also be updated (e.g., the optimization criteria may be re-weighted/re-ranked upon a prompt to a user and/or the optimization data may be updated based on current network conditions). The updated information may be stored and used to generate an updated list of provider site candidates. For example, the optimization system may periodically generate an updated list of provider site candidates based on updated service information, updated optimization data, and/or updated optimization criteria to determine if a different (e.g., second) provider site is now recommended more highly then the then-current provider site. In examples, the updated service information and/or updated optimization data may be used to calculate an improvement metric for any one or more of the optimization criteria. For example, the optimization system may, in response to receiving or determining updated service information, determine that moving the computing service from the first provider site to the second provider site will result in an average latency improvement of X%. In examples, the improvement metric may be calculated each time updated service information, optimization data, or optimization criteria is received (or on some other periodic schedule) so that it can be measured over one or more period(s) of time. In examples, the service information (and/or optimization data and/or optimization criteria) may also be updated in response to a change event, such as a service failure at the first provider site.

Based on the updated information, the optimization system may determine that a second provider site is recommended for the computing service. If so, some or all of the computing service may be moved to the second provider site, either in response to approval from a user and/or automatically. For example, the trigger to move the computing service may be any of (a) an improvement metric exceeding a threshold for a minimum period; (b) a failure at the then-current provider site; and/or (c) user request/approval. In examples where an improvement metric is calculated, a computing service may not be moved until the improvement metric exceeds the threshold for a minimum period (e.g., a 20% improvement of estimated average latency each week for a period of one month). This can help eliminate excessive moves within the provider network based on temporary improvements. In examples where an updated list of provider site candidates is determined in response to a failure of the then-current provider site, the computing service may be moved to the second provider site immediately because the first provider site, e.g., is failing. However, unlike systems where the second provider site is a dedicated backup site for the first provider site, the second provider site can be dynamically determined to be optimal based on then-current updated service information, optimization data, and/or optimization criteria.

In examples, the optimization system may be in communication with a configuration system that can be used to deploy and/or instantiate the computing service at the selected provider site(s). In examples, this may include automatically procuring hardware, operating system(s), data storage, and/or network connectivity to allow the computing service to be hosted and accessed by the customer. In examples, the configuration system may be automatically instructed by the optimization system to instantiate and/or move the computing service to one or more provider site(s). In other examples, user approval may be required and/or a client device may be redirected to the configuration system in order to effect the instantiation/move of the computing service at the selected provider site(s).

In some examples, the provider network and/or the optimization system may make available one or more application programming interfaces (APIs) that can consume network performance information from one or more other network provider(s). For example, a second network provider may provide information about network connectivity and performance/latency information for a second provider network. In examples, the provider network may need to connect to or through such other provider network(s) in order to host the computing service for the customer. In other examples, using such other provider network(s) may be more efficient or cost effective for the customer.

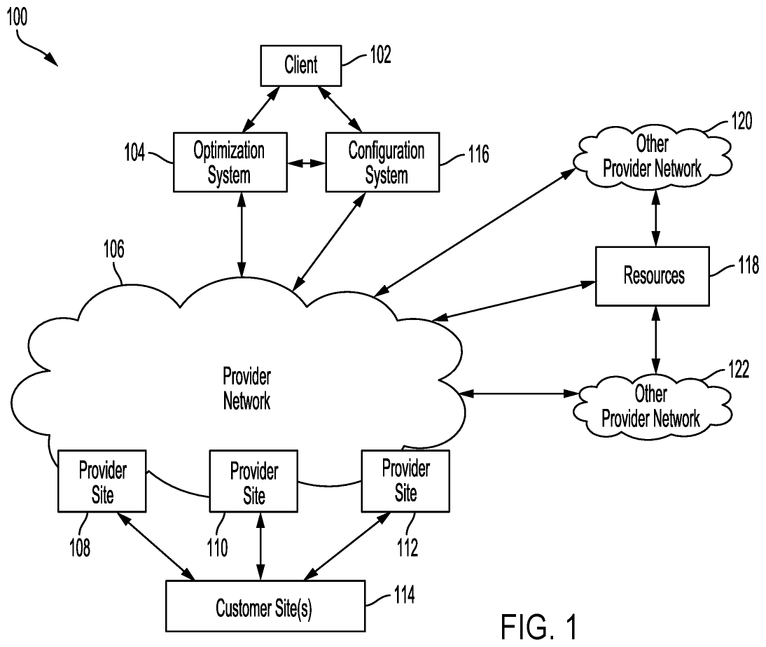

FIG. 1 is an example system for hosting a computing service according to embodiments. In examples, a client device 102 may access an optimization system 104 associated with a provider network 106. In examples, the optimization system 104 operates on a computing device that is part of, or communicatively coupled to, the provider network 106.

Provider network 106 may comprise a communications network that includes a plurality of communicatively coupled devices for transmitting, storing, computing, and otherwise processing electronic information. For example, provider network 106 may comprise routers, switches, gateway devices, data storage devices, servers, and other computing devices. In examples, the provider network 106 may also comprise a plurality of provider sites 108, 110, 112. Although three provider sites are depicted, any number of provider sites may be provided.

In examples, provider sites 108, 110, and 112 are edge computing sites located at or near the edge of provider network 106. For example, provider sites 108, 110, and 112 may each include at least one provider edge router, which operates as an ingress point into provider network 106 for communications from customer site(s) 114. Customer site(s) 114 may be geographically dispersed for a variety of customers. In addition, a single customer may have multiple, geographically dispersed customer site(s) 114. Provider sites 108, 110, and 112 may also include computing capabilities (e.g., servers) and data storage to permit the provider sites 108, 110, and 112 to host computing services. Provider sites 108, 110, and 112 may be operatively connected to customer site(s) through a variety of other networks or communication links, including private networks, public networks, and/or a hybrid of public and private networks. In examples, having provider sites 108, 110, and 112 at or near the edge of provider network 106 permit the customer site(s) 114 to minimize latency (among other things), particularly when the provider site is selected, in part, based on the proximity of that provider site to the customer site(s) 114 that need access to the provider site. In addition, the provider sites 108, 110, and 112 may not be uniform—e.g., they may differ in computing capability, security certification, capacity for expansion, data storage availability, type of network connectivity (e.g., public internet, private networking, hybrid public/private), etc. Accordingly, selection of a provider site 108, 110, and/or 112 for particular computing service to be hosted for customer site(s) 114 is optimized based on a variety of factors.

In examples, the optimization system 104 uses both service information and optimization criteria to determine one or more optimized provider site(s) 108, 110, and/or 112 for hosting a computing service. As discussed, the service information may comprise information about the computing service to be hosted, such as the type of software application(s) to be executed, data storage requirements, required computing capacity, operating system(s), network connectivity (e.g., public internet, private networking, hybrid, etc.), security requirements (e.g., particular security needed, such as payment card industry (PCI) security certification), latency requirements (e.g., maximum average latency), internet protocol (IP) addresses and/or destinations/entities that need to be reached, type of data traffic (e.g., voice, video) that will be sent to and from the computing service, and the physical location of customer site(s) 114 that will be accessing the hosted computing service, etc.

For example, the service information may include that the computing service comprises a payments application that needs to reach IP addresses of certain external resources 118 (files, code, data, etc.), requires 100 megabytes of local storage, private connectivity, to be hosted on a 2 U server running a Linux operating system, where the site is PCI compliant, accessible from customer sites 114 in Pittsburgh, Pa. and New York, N.Y. with a maximum average latency of 5 milliseconds. Optimization criteria may include performance, reliability (e.g., uptime), average latency, cost, security rating, etc.

In examples, some or all of the service information may be received through a user interface that the optimization system 104 provides to the client device 102. For example, the user interface may be provided for a customer (or provider representative) to enter some or all of the service information. In some examples, the user interface may be dynamically rendered using a template selected by the optimization system 104 based on the answer(s) to initial question(s) about the computing service, e.g., type of software application, data storage requirement(s), etc. In other examples, some or all of the service information may be automatically discovered. For example, if the computing service is already being hosted on the provider network 106, the provider network 106 may already store information related to the type of software application, data storage requirements, type and size of data traffic, IP addresses and/or destinations/entities that need to be reached, physical location of customer site(s), etc. As such, the optimization system 104 may query one or more devices of the provider network 106 to determine some or all of the service information needed by the optimization system 104.

Similarly, some or all of the optimization criteria may be received through a user interface presented by optimization system 104 to client device 102. Optimization criteria may include performance, reliability (e.g., uptime), average latency, cost, security rating, etc. In some examples, a predetermined set of optimization criteria may be presented through the user interface to a user, and the user may be provided an opportunity to rank and/or weight the optimization criteria in terms of importance to the customer. In other examples, a standard set of optimization criteria may be used, or optimization criteria specific to a type of computing service to be hosted may be used without user ranking/weighting.

The optimization system 104 may also collect optimization data for each provider site 108, 110, 112 corresponding to the optimization criteria. For example, if an optimization criterion is average latency between a provider site 108, 110, 112 and one or more customer site(s) 114 for a particular type of application specified in the service information, the optimization data for that optimization criterion may be a measured or estimated latency time between the provider site 108, 110, and/or 112 and the customer site(s) 114 (e.g., 5 milliseconds). Optimization data can then be used to determine one or more optimized provider site(s).

In examples, optimization system 104 may employ a scoring matrix to score provider site candidates based on the optimization criteria (and corresponding optimization data), e.g., as the optimization criteria are ranked and/or weighted. For example, the optimization criteria may include some criteria that are denoted as mandatory—e.g., must have PCI security certification. Whereas, other optimization criteria may correspond to optimization data that is measurable and subject to ranking/sorting/weighting. As an example, if the optimization criteria indicate that a provider site 108, 110, or 112 must have PCI security certification and must have at least 100 megabytes of available data storage, the optimization system 104 may include on the list of provider site candidates only provider sites 108, 110, and/or 112 that meet those requirements. Within the list of provider site candidates, the candidates may be ordered (or sortable) based on one or more other optimization criteria (and corresponding optimization data) (e.g., ascending order from least cost to highest cost, or from least latency to highest latency, etc.).

The list of provider site candidates may be presented to a user of client device 102 for selection of a provider site 108, 110, and/or 112 to host the computing service. The list of provider site candidates may be presented along with optimization data for some or all of the optimization criteria so that a user can view, e.g., the estimated costs, performance, reliability, security rating, average latency, etc. associated with each of the provider site candidates in determining a provider site 108, 110, and/or 112 to choose. In examples, the list of provider site candidates may also be sortable/reordered by a user on any of the optimization criteria, among other things. For example, the list of provider site candidates may first be presented in ascending order of cost, but it may be then sorted by a user to be ordered in ascending order of estimated latency.

In examples, the optimization system 104 may provide the client device 102 with the opportunity to cause the computing service to be deployed/instantiated at one or more of the provider sites 108, 110, and/or 112. In examples, the optimization system 104 may be in communication with a configuration system 116 that can be used to automatically deploy and/or instantiate the computing service at the selected provider site(s) 108, 110, and/or 112. In examples, configuration system 116 may cause hardware, operating system(s), data storage, and/or network connectivity to be procured within provider network 106 to allow the computing service to be hosted at the selected provider site 108, 110, and/or 112 and accessed by from customer site(s) 114. In examples, the configuration system 116 may be automatically instructed by the optimization system 104 to instantiate and/or move the computing service to one or more provider site(s) 108, 110, and/or 112. In other examples, client device 102 may be redirected by the optimization system 104 to the configuration system 116 in order to effect the instantiation/move of the computing service at the selected provider site(s) 108, 110, and/or 112.

In other examples, the list of provider site candidates may be used to automatically cause the computing service to be deployed (or moved, as explained further below) to particular provider site(s) 108, 110, and/or 112 without a user selection of a particular provider site 108, 110, and/or 112. For example, the provider network 106 may be self-configuring based on the service information, optimization data, and optimization criteria. Optimization system 104 may decide on which provider site(s) 108, 110, and/or 112 to host (or move) the computing service without the customer making any final selection of the provider site(s) 108, 110, and/or 112, which selection may be invisible to the customer.

In examples, after an initial deployment of the computing service to a first provider site (such as provider site 108), updated service information, optimization data, and/or optimization criteria may be determined. In examples, the optimization criteria, optimization data, and the initial service information may be saved following the initial deployment. Static service information may remain unchanged in the updated service information, such as the type of software application, network connectivity (e.g., public internet, private networking, hybrid, etc.), security requirements (e.g., particular security needed, such as payment card industry (PCI) security certification), etc. However, other service information that may have been estimated for the initial deployment may be replaced with information about the computing service as it has been actually deployed at the first provider site 108. For example, actual metrics may be determined for the data storage being used, operating system(s) used, average latency, internet protocol (IP) addresses and/or destinations/entities being connected, type and size of data traffic (e.g., voice, video) that is being sent to and from the computing service, and the physical location of customer site(s) 114 that have been accessing the hosted computing service, etc. In examples, updated service information may be determined and/or redetermined periodically or in response to a failure of provider site(s) (discussed below).

The optimization data and/or optimization criteria may also be updated (e.g., the service criteria may re-weighted/re-ranked upon a prompt to a user of client device 102 and the optimization criteria may be re-determined based on the updated service information and/or updated optimization criteria). The updated service information, optimization data, and/or optimization criteria may then be used to generate an updated list of provider site candidates. For example, the optimization system 104 may periodically generate an updated list of provider site candidates based on updated service information, updated optimization data, and/or updated optimization criteria to determine if a different (e.g., second) provider site (e.g., provider site 110) is now recommended over then-current provider site(s).

In examples, the updated information may be used to calculate an improvement metric for any one or more of the optimization criteria. For example, the optimization system may, in response to receiving or determining updated service information, updated optimization criteria and/or updated optimization data, determine that moving the computing service from the first provider site 108 to the second provider site 110 will result in an average latency improvement of X%. In examples, the improvement metric may be calculated each time updated service information, updated optimization criteria and/or updated optimization data is received (or on some other periodic schedule) so that it can be measured over one or more period(s) of time. In examples, the service information, optimization criteria and/or optimization data may also be updated in response to a failure event, such as a service failure at the first provider site 108.

Based on the updated service information, optimization criteria, and/or optimization data, the optimization system 104 may determine that a second provider site 110 is recommended for the computing service over the current provider site 108. If so, some or all of the computing service may be moved to the second provider site 110 from first provider site 108, either in response to approval from a user and/or automatically in response to a change event. Examples of change events may comprise an improvement metric exceeding a threshold for a period of time, and/or a failure of an existing provider site. For example, the trigger to move the computing service may be any of (a) an improvement metric exceeding a threshold for a minimum period; (b) a failure of the first provider site; and/or (c) user request/approval. In examples where an improvement metric is calculated, a computing service may not be moved until the improvement metric exceeds the threshold for a minimum period (e.g., a 20% improvement of estimated average latency each week for a period of one month). This can help eliminate excessive moves within the provider network 106 based on temporary improvements. In examples where an updated list of provider site candidates is determined in response to a failure of the first provider site, the computing service may be moved to the second provider site 110 immediately because the first provider site 108, e.g., is failing. However, unlike systems where the second provider site 110 is a dedicated backup site for the first provider site 108, the second provider site 110 can be dynamically determined to be optimal based on then-current updated service information, optimization criteria, and optimization data. If, for example, the service information, optimization data, and/or optimization criteria are later updated, it may be determined that provider site 112 should be the backup for provider site 108, if provider site 108 fails.

In some examples, the provider network and/or the optimization system may make available one or more application programming interfaces (APIs) that can consume network performance information from one or more other provider networks 120, 122. In examples, the APIs may be provided as part of optimization system 104. For example, a second network provider may provide information about network connectivity and performance/latency information for a second provider network 120 and/or 122. In examples, the provider network 106 may need to connect to or through such other provider network(s) 120, 122 in order to reach resources 118 used in hosting the computing service for the customer. In other examples, using such other provider network(s) 120, 122 may be more efficient or cost effective for the customer than accessing the resources 118 directly by provider network 106.

In examples, the other provider network(s) 120, 122 may also include provider sites that are logically closer to one or more customer site(s) and contain computing and/or data storage capabilities and are sufficient to provide a requested computing service to a customer. As such, the other provider network(s) 120, 122 may also submit, through the APIs, information about computing and data storage available at provider site(s) existing within provider network(s) 120, 122. In examples, the optimization system 104 may receive computing, data storage, and network performance information from such other provider network(s) 120, 122 and treat it as optimization data for the purposes of determining a recommended provider site and/or network connectivity to host a computing service for the customer. In this manner, optimization system 104 can act as a provider-agnostic clearinghouse for network, storage, and computing services of various providers.

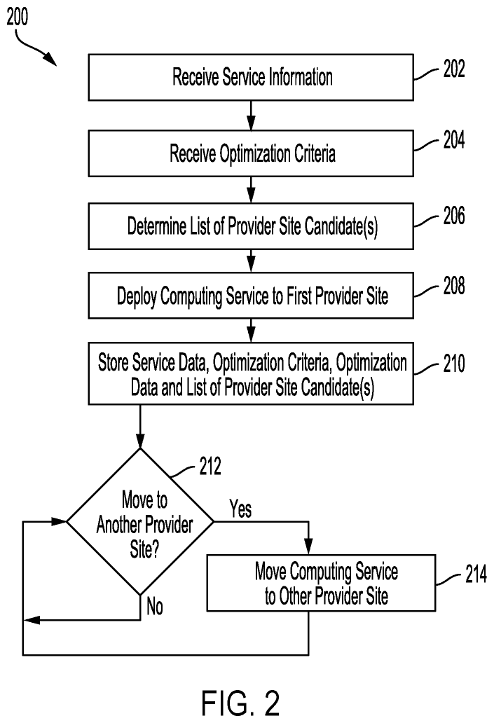

FIG. 2 depicts a method 200 for recommending a provider site and for deploying a computing service to the provider site. In examples, some or all of the operations of method 200 may be performed by an optimization system, such as the optimization system 104 of system 100. At operation 202, service information for a computing service is received. In examples, optimization system 104 receives the service information through a user interface from client device 102. In other examples, some or all of the service information may be automatically discovered from computing devices associated with provider network 106. As discussed, examples of service information include the type of software application(s) to be executed, data storage requirements, required computing capacity, operating system(s), network connectivity (e.g., public internet, private networking, hybrid, etc.), security requirements (e.g., particular security needed, such as payment card industry (PCI) security certification), latency requirements (e.g., maximum average latency), internet protocol (IP) addresses and/or destinations/entities that need to be reached, type of data traffic (e.g., voice, video) that will be sent to and from the computing service, and the physical location of customer site(s) 114 that will be accessing the hosted computing service, etc.

Flow proceeds to operation 204, where optimization criteria are received through a user interface. For example, optimization system 104 may receive the optimization criteria through a user interface from client device 102. As discussed, examples of optimization criteria may include performance, reliability (e.g., uptime), average latency, cost, security rating, etc. In some examples, a predetermined set of optimization criteria may be presented through the user interface to a user, and the user may be provided an opportunity to rank and/or weight the optimization criteria in terms of importance. In other examples, a standard set of optimization criteria may be used, or optimization criteria specific to a type of computing service to be hosted may be used without user ranking/weighting.

Flow proceeds to operation 206, where a plurality of provider site candidates for the computing service may be determined based on the service information and the optimization criteria. In examples, optimization system 104 may determine a plurality of provider site candidates for the computing service, including at least a first provider site (e.g., provider site 108 of a provider network 106). For example, the optimization system may determine optimization data for each of the optimization criteria. Optimization data may comprise measured or estimated values for the optimization criteria. For example, if a first optimization criterion is average latency between a provider site 108 and customer site(s) 114, then optimization data for that optimization criteria might be 5 milliseconds. Other optimization data may be binary values. For example, if the optimization criterion is PCI certification, then the corresponding optimization data for a particular provider site may be yes or no.

As discussed, in examples, the provider network 106 and/or the optimization system 104 may make available one or more APIs that can consume network performance information and/or computing and storage capability information from one or more other provider networks 120, 122. In examples, the optimization system 104 may treat the computing, data storage, and network performance information received from such other provider network(s) 120, 122 as optimization data for the purposes of determining a recommended provider site and/or network connectivity to host a computing service for the customer.

In examples, optimization system 104 may employ a scoring matrix to score provider site candidates based on the optimization criteria (and corresponding optimization data), e.g., as the optimization criteria are ranked and/or weighted. For example, the optimization criteria may include some criteria that are denoted as mandatory—e.g., must have PCI security certification. Whereas, other optimization criteria may be measurable and subject to ranking/sorting/weighting. As an example, if the optimization criteria includes that a provider site 108, 110, or 112 must have PCI security certification and must have at least 100 megabytes of available data storage, the optimization system 104 may include on the list of provider site candidates only provider sites 108, 110, and/or 112 that meet those requirements. Within the list of provider site candidates, the candidates may be ordered (or sortable) based on one or more other optimization criteria (e.g., ascending order from least cost to highest cost, or from least latency to highest latency, etc.).

Flow proceeds to operation 208, where the computing service is deployed to a first provider site. For example, as discussed, the list of provider site candidates may be sent by optimization system 104 to client device 102 for selection of a provider site 108, 110, and/or 112 to host the computing service. The list of provider site candidates may be presented along with optimization data for some or all of the optimization criteria and optimization data so that a user can view, e.g., the estimated costs, performance, reliability, security rating, average latency, etc. associated with each of the provider site candidates in determining a provider site 108, 110, and/or 112 to choose. In examples, the optimization system 104 may provide the client device 102 with the opportunity to cause the computing service to be deployed/instantiated at one or more of the selected provider site(s) 108, 110, and/or 112. In examples, the optimization system 104 may be in communication with a configuration system 116 that can be used to deploy and/or instantiate the computing service at the selected provider site(s) 108, 110, and/or 112. In examples, configuration system 116 may cause hardware, operating system(s), data storage, and/or network connectivity to be procured within provider network 106 to allow the computing service to be hosted at the selected provider site 108, 110, and/or 112 and accessed by from customer site(s) 114. In examples, the configuration system 116 may be automatically instructed by the optimization system 104 to instantiate and/or move the computing service to one or more provider site(s) 108, 110, and/or 112. In other examples, client device 102 may be redirected by the optimization system 104 to the configuration system 116 in order to effect the instantiation of the computing service at the selected provider site(s) 108, 110, and/or 112.

In other examples, the list of provider site candidates may be used to automatically cause the computing service to be deployed to particular provider site(s) 108, 110, and/or 112 without a user selection of a particular provider site 108, 110, and/or 112. For example, the provider network 106 may be self-configuring based on the service information, optimization data, and optimization criteria. Optimization system 104 may decide on which provider site(s) 108, 110, and/or 112 to host the computing service without the user making any final selection of the provider site(s) 108, 110, and/or 112, which decision may be invisible to the customer. The optimization system 104 may then instruct the configuration system to automatically deploy and/or instantiate the computing service at the selected provider site(s) 108, 110, and/or 112.

Flow proceeds to operation 210, where the service information, optimization data, and optimization criteria are stored. In examples, optimization system 104 stores the service information, optimization criteria and the corresponding optimization data determined at operation 206. In examples, operation 210 may also include storing the list of provider site candidates determined at operation 206. Optimization criteria, optimization data, and/or the list of provider site candidates may be stored at optimization system 104 and/or in data storage accessible to optimization system 104. Optimization criteria may be stored along with any ranking/ordering for such optimization criteria that was received in operation 204. In examples, optimization data and/or the list of provider site candidates may be stored with an associated time-to-live value, which may vary depending on the particular type of optimization data. For example, some optimization data may be relatively stable (e.g., whether a provider site is PCI certified), while other optimization data may fluctuate more often based on provider network conditions (such as an average latency). As such, some optimization data may be given a longer time-to-live value than others. In examples, the most-recently produced list of provider site candidates is always stored in case it is needed for a fast move of the computing service (e.g., in case of a failure at a provider site).

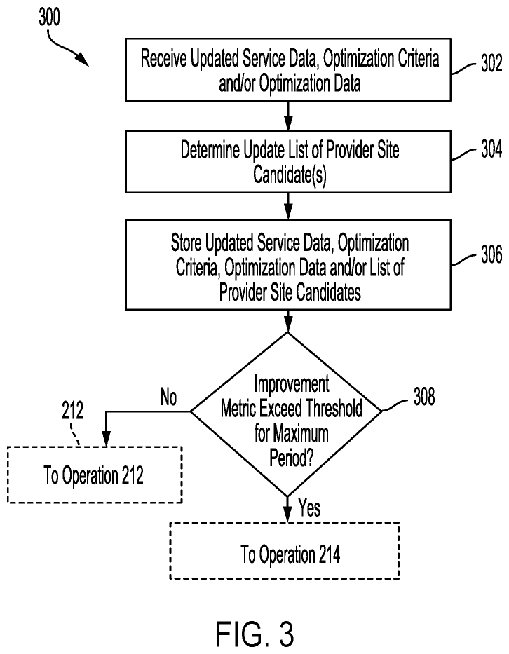

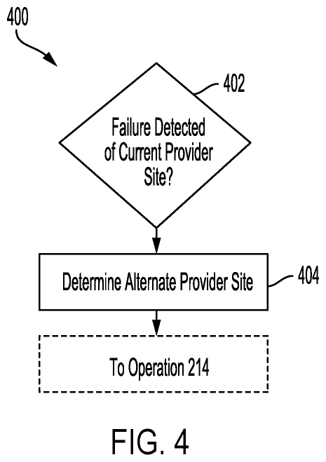

Flow proceeds to operation 212, where it is determined whether to move the computing service to another provider site. The decision at operation 212 whether to move some or all of the computing service to one or more other provider site(s) may be based on a variety of factors and/or triggers. For example, the decision operation 212 may be triggered based on detection of a change event. Examples of a change event can include an improvement metric exceeding a threshold for a minimum period of time, a failure of the then-current provider site, and/or user request/approval. Examples of operation 212 are described with respect to FIGS. 3 and 4. If the decision is made not to move the computing service to another provider site, the method loops back to operation 212 until a decision is made to move the computing service to another provider site.

If the decision is made to move at least a portion of the computing service to another provider site, flow branches to operation 214, where at least a portion of the computing service is moved to another provider site. For example, at operation 214, the computing service may be redeployed at a second provider site. In examples, this may include moving all traffic from the first provider site to the second provider site. In other examples, operation 214 may comprise adding second provider site without disabling the first provider site so that the traffic for the computing service may be split between the first provider site and the second provider site. For example, traffic from one customer site 114 may be moved to the second provider site, while traffic from certain customer site(s) 114 may still be directed to the then-current (e.g., first) provider site. Operation 214 may be performed by the optimization system 104 in conjunction with the configuration system 116. For example, the optimization system 104 may instruct the configuration system 116 to procure any necessary computing and networking resources necessary to instantiate the computing service at the second provider site. In examples, the configuration system may also configure directory servers of provider network 106 (such as DNS servers) to redirect some or all of the traffic from all (or only certain) of the customer site(s) 114 to the second provider site. In examples, operation 214 may be performed automatically upon determination in operation 212 that the computing service should be moved. In other examples, operation 214 may be performed only after receiving user approval, e.g., from client device 102. After the computing service is moved to another provider site, flow loops back to operation 212.

FIG. 3 depicts a method 300 that is one example of decision operation 212. At operation 302, updated service data, optimization criteria, and/or optimization data are received. For example, optimization system 104 may be configured to periodically update one or both of the service data and the optimization data by periodically collecting network performance data and/or computing performance data while the computing service is being hosted at the then-current provider site. In other examples, a user of client 102 may prompt optimization system 104 to update the service data and/or optimization data. Further, a customer may initiate, or be prompted to initiate, an update of the optimization criteria. For example, the optimization system 104 may receive new optimization criteria from client 102 and/or a new weighting or ranking for the optimization criteria.

At operation 304, an updated list of provider site candidates is automatically determined based on the updated service data, optimization criteria, and/or optimization data. For example, the optimization system 104 may, in response to receiving the updated information at operation 302, use the updated service data, optimization criteria, and/or optimization data to generate a new list of provider site candidates. In examples, optimization system 104 may employ again a scoring matrix to score provider site candidates based on the updated service data, optimization criteria (and corresponding optimization data), e.g., as the optimization criteria are ranked and/or weighted. Within the list of provider site candidates, the candidates may be ordered (or sortable) based on one or more other optimization criteria (e.g., ascending order from least cost to highest cost, or from least latency to highest latency, etc.).

At operation 306, the updated service data, optimization criteria, and/or optimization data are stored. In addition, the re-calculated list of provider site candidates may also be stored. For example, the updated information may be stored in addition to the information that was stored at operation 210, or may replace some or all of the information stored at operation 210. In examples, the previous service data, optimization criteria, and/or optimization data and the previously calculated list of provider candidates is stored for a period of time so that comparisons can be made over time.

At operation 308, it is determined whether an improvement metric has exceeded a threshold for a minimum period. In examples, the optimization system 104 may determine whether any provider site(s) in the updated provider site candidates list is recommended over the provider site currently hosting the computing service. A determination can then be made whether the now-recommended provider site from the re-calculated provider site candidate list determined at operation 304 shows a sufficient improvement over the then-current provider site (e.g., first provider site) to warrant a change. In examples, the improvement metric can comprise a difference between the overall weighted score for the second (alternate) provider site versus the first (current) provider site based on the scoring matrix used at operation 304. In addition, the improvement metric may be measured over a minimum time period. For example, in the simple example where the improvement metric comprises only one criterion (e.g., latency), operation 308 may comprise determining whether the average latency of the second provider site is at least X% better than the average latency at the first provider site, and has been for at least a minimum period of time (e.g., one month).

If the improvement metric is determined at operation 308 not to exceed a threshold for a minimum period, then flow loops back to operation 212. If the improvement metric is determined at operation 308 to exceed a threshold for a minimum period, then flow proceeds to operation 214 in FIG. 2, where at least a portion of the computing service is moved.

FIG. 4 depicts a method 400 that is another example of decision operation 212. At operation 402, it is determined whether a failure has been detected at the then-current provider site(s). For example, the then-current provider site(s) (e.g., the first provider site) may become unreachable and/or may become subject to an attack, such as a distributed denial of service (DDoS) attack. In examples, optimization system 104 may receive an indication of the failure at the then-current provider site(s) from one or more elements of provider network 106. If no failure has been detected at the then-current provider site(s), flow proceeds back to operation 212 in FIG. 2.

At operation 404, if a failure at the then-current provider site has been detected, an alternate provider site is determined. In examples, operation 404 may comprise determining, in response to detecting the failure at the then-current provider site in operation 402, a now-recommended provider site for the computing service. In examples, operation 404 may comprise retrieving a most-recent, stored list of provider site candidates and selecting the highest-recommended alternative provider site on that list. For example, the original list of provider site candidates determined at operation 206 can be retrieve from storage and used. In other examples, the provider site candidates list may have been updated and stored, e.g., at operations 304 and 306, and the stored, updated list may be used. In examples, the most-recent, stored list of provider site candidates might be used in order to remedy the failure at the then-current provider site as quickly as possible.

In other examples of operation 404, in response to detecting the failure at the then-current provider site in operation 402, the optimization system 104 may request and receive updated service data, optimization criteria, and/or optimization data. The newly updated service data, optimization criteria, and/or optimization data may then be used to generate a new list of provider site candidates from which an alternative provider site may be determined. Once the alternative provider site is determined, flow proceeds to operation 214 in FIG. 2, where at least a portion of the computing service is moved.

In examples, one or both of methods 300 and 400 can be used as determining operation 212. For example, operation 212 may flow yes to operation 214 if either the improvement metric exceeds a threshold amount for a minimum period at operation 308 or failure is detected at the current provider site(s) at operation 402 and an alternate provider site is determined at operation 404.

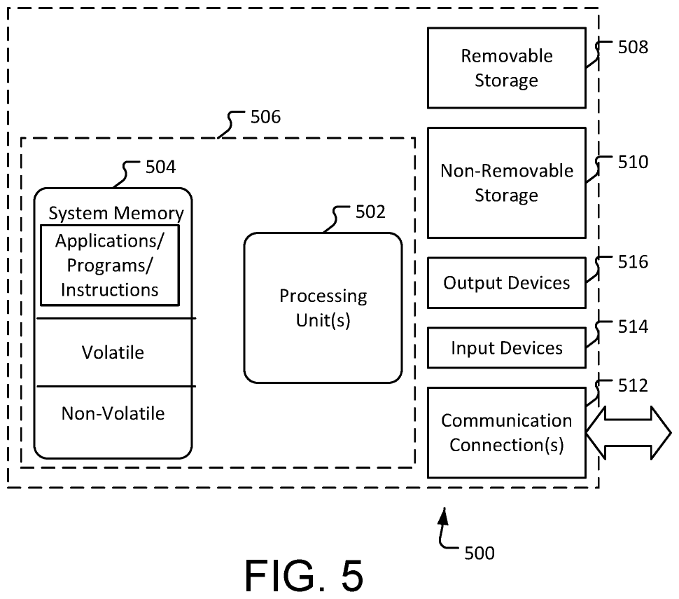

FIG. 5 depicts an example environment 500 with which aspects of the present systems and methods may be practiced. For example, one or more of client device 102, optimization system 104, components of provider network 106, provider sites 108, 110, 112, customer site(s) 114, resources 118, other provider networks 120, 122, can take the form, in whole or in part, of environment 500 in FIG. 5.

In its most basic configuration, operating environment 500 typically includes at least one processing unit 502 and memory 504. Depending on the exact configuration and type of computing device, memory 504 (storing, instructions to perform the techniques disclosed herein) may be volatile (such as RAM), non-volatile (such as ROM, flash memory, etc.), or some combination of the two. This most basic configuration is illustrated in FIG. 5 by dashed line 506. Further, environment 500 may also include storage devices (removable, 508, and/or non-removable, 510) including, but not limited to, magnetic or optical disks or tape. Similarly, environment 500 may also have input device(s) 514 such as keyboard, mouse, pen, voice input, etc. and/or output device(s) 516 such as a display, speakers, printer, etc. Also included in the environment may be one or more communication connections 512, such as LAN, WAN, point to point, etc. In embodiments, the connections may be operable to facility point-to-point communications, connection-oriented communications, connectionless communications, etc.

Operating environment 500 typically includes at least some form of computer readable media. Computer readable media can be any available media that can be accessed by processing unit 502 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, non-transitory medium which can be used to store the desired information. Computer storage media does not include communication media.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, microwave, and other wireless media. Combinations of the any of the above should also be included within the scope of computer readable media.

The operating environment 500 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

The embodiments described herein may be employed using software, hardware, or a combination of software and hardware to implement and perform the systems and methods disclosed herein. Although specific devices have been recited throughout the disclosure as performing specific functions, one of skill in the art will appreciate that these devices are provided for illustrative purposes, and other devices may be employed to perform the functionality disclosed herein without departing from the scope of the disclosure.

Reference to “one example” or “an example” means that a particular feature, structure, or characteristic described in connection with the example is included in at least one example of the disclosure. The appearances of the phrase “in one example” in various places in the specification are not necessarily all referring to the same example, nor are separate or alternative examples mutually exclusive of other examples. Moreover, various features are described which may be exhibited by some examples and not by others.

This disclosure describes some embodiments of the present technology with reference to the accompanying drawings, in which only some of the possible embodiments were shown. Other aspects may, however, be embodied in many different forms and should not be construed as limited to the embodiments set forth herein. Rather, these embodiments were provided so that this disclosure was thorough and complete and fully conveyed the scope of the possible embodiments to those skilled in the art.

Although specific embodiments are described herein, the scope of the technology is not limited to those specific embodiments. One skilled in the art will recognize other embodiments or improvements that are within the scope and spirit of the present technology. Therefore, the specific structure, acts, or media are disclosed only as illustrative embodiments. The scope of the technology is defined by the following claims and any equivalents therein.

What is claimed is:

1. A method, comprising:
receiving service information for a computing service;
receiving, through a user interface, optimization criteria;
determining, based on the service information and the optimization criteria, a plurality of provider site candidates for the computing service, including at least a first provider site of a provider network;
deploying the computing service at the first provider site;
storing the optimization criteria;
automatically determining, based on the stored optimization criteria, a second provider site of the provider network;
detecting a change event; and
deploying the computing service at the second provider site.

2. The method of claim 1, wherein the change event comprises a service failure.

3. The method of claim 1, wherein detecting the change event comprises determining that an improvement metric for deploying the computing service at the second provider site exceeds a threshold for a predetermined amount of time.

4. The method of claim 1, wherein determining a plurality of provider site candidates comprises determining optimization data corresponding to the optimization criteria, and wherein automatically determining the second provider site occurs after deploying the computing service at the first provider site, further comprising:
determining updated information comprising at least one of updated service information and updated optimization data for the computing service after deployment of the computing service at the first provider site, wherein the updated service information includes network performance information for the provider network;
wherein the automatically determining the second provider site is based on the updated information and the stored optimization criteria.

5. The method of claim 4, further comprising:
determining second updated information for a second computing service deployed on the first provider site;
automatically determining, based on the optimization criteria and the second updated information, a third provider site of the provider network;
deploying the second computing service to the third provider site.

6. The method of claim 4, wherein determining the updated information and automatically determining the second provider site both occur periodically after deployment of the computing service at the first provider site.

7. The method of claim 1, wherein automatically determining the second provider site is performed in response to detecting the change event.

8. The method of claim 4, wherein determining updated information for a computing service comprises detecting the updated customer service information based on operating metrics of the computing service deployed at the first provider site.

9. The method of claim 1, further comprising:
determining a type of application for the computing service;
retrieving a template corresponding to the type of application;
customizing the user interface based on the template, wherein the user interface prompts a user to input at least some of the service information and at least some of the optimization criteria.

10. The method of claim 3, wherein determining that an improvement metric for deploying the computing service at the second provider site exceeds the threshold for the predetermined amount of time comprises evaluating network performance information of the provider network and computing availability at the second provider site.

11. The method of claim 10, further comprising:
providing an application programming interface (API); and
receiving additional network performance information from a different provider through the API;
wherein evaluating the network performance information comprises evaluating the additional network performance information to determine whether to utilize the different provider in providing network connectivity to the second provider site.

12. A system, comprising:
at least one processor;
memory, operatively connected to the at least one processor and storing instructions that, when executed by the at least one processor, cause the system to perform a method, the method comprising:
receiving service information for a computing service;
receiving, through a user interface, optimization criteria;
determining, based on the service information and the optimization criteria, a plurality of provider site candidates for the computing service, including at least a first provider site of a provider network;
deploying the computing service at the first provider site;
storing the optimization criteria;
automatically determining, based on the stored optimization criteria, a second provider site of the provider network;
detecting a change event; and
deploying the computing service at the second provider site.

13. The system of claim 12, wherein the change event comprises a service failure.

14. The system of claim 12, wherein detecting the change event comprises determining that an improvement metric for deploying the computing service at the second provider site exceeds a threshold for a predetermined amount of time.

15. The system of claim 12, wherein determining a plurality of provider site candidates comprises determining optimization data corresponding to the optimization criteria, and wherein automatically determining the second provider site occurs after deploying the computing service at the first provider site, the method further comprising:
determining updated information comprising at least one of updated service information and updated optimization data for the computing service after deployment of the computing service at the first provider site, wherein the updated service information includes network performance information for the provider network;
wherein the automatically determining the second provider site is based on the updated information and the stored optimization criteria.

16. The system of claim 15, wherein the method further comprises:
determining second updated information for a second computing service deployed on the first provider site;
automatically determining, based on the optimization criteria and the second updated information, a third provider site of the provider network;
deploying the second computing service to the third provider site.

17. A method, comprising:
receiving service information for a computing service;
receiving, through a user interface, optimization criteria;
determining optimization data corresponding to the optimization criteria;
determining, based on the service information, the optimization data, and the optimization criteria, a plurality of provider site candidates for the computing service, including at least a first provider site of a provider network;
deploying the computing service at the first provider site;
storing the service information, the optimization criteria, and the optimization data;
receiving updated information comprising at least one of updated service information, updated optimization criteria, and updated optimization data;
automatically determining, based on the updated information, an updated plurality of provider site candidates for the computing service;
determining that an improvement metric for deploying the computing service at a second provider site of the updated plurality of provider site candidates exceeds a threshold for a predetermined amount of time; and
deploying, in response to determining that the improvement metric exceeds the threshold for the predetermined amount of time, the computing service at the second provider site.

18. The method of claim 17, wherein determining the updated information and automatically determining the updated plurality of provider site candidates both occur periodically after deployment of the computing service at the first provider site.

19. The method of claim 17, wherein determining updated information comprises detecting the updated customer service information based on operating metrics of the computing service deployed at the first provider site.

20. The method of claim 17, further comprising:
determining a type of application for the computing service;
retrieving a template corresponding to the type of application;
customizing the user interface based on the template, wherein the user interface prompts a user to input at least some of the service information and at least some of the optimization criteria.
